(19) United States
(12) Patent Application Publication
(10) Pub. No.: US 2023/0246182 A1
(43) Pub. Date: Aug. 3, 2023

(54) ADDITIVES FOR HIGH-NICKEL ELECTRODES AND METHODS OF FORMING THE SAME

(71) Applicant: GM GLOBAL TECHNOLOGY OPERATIONS LLC, Detroit, MI (US)

(72) Inventors: Roland J. KOESTNER, Rochester Hills, MI (US); Bradley R. FRIEBERG, Farmington Hills, MI (US); Mengyuan CHEN, Madison Heights, MI (US)

(73) Assignee: GM GLOBAL TECHNOLOGY OPERATIONS LLC, Detroit, MI (US)

(21) Appl. No.: 17/591,740

(22) Filed: Feb. 3, 2022

(51) Int. Cl. H01M 4/525; H01M 4/62; H01M 4/36; H01M 4/505; H01M 4/04; H01M 4/1391

(52) U.S. Cl. CPC H01M 4/525; H01M 4/623; H01M 4/625; H01M 4/364; H01M 4/505; H01M 4/0404; H01M 4/1391

(57) ABSTRACT

An electrode is provided that includes a high-nickel electroactive material having greater than or equal to about 0.6 mole fraction of nickel, and greater than or equal to about 0.1 wt. % to less than or equal to about 2 wt. % of a sulfonated aromatic ionomer additive. The electrode is prepared by contacting an electroactive material slurry with one or more surfaces of a current collector, where a solids portion of the slurry includes greater than or equal to about 45 wt. % to less than or equal to about 99 wt. % of a high-nickel electroactive material, and greater than or equal to about 0.1 wt. % to less than or equal to about 2 wt. % of a sulfonated aromatic ionomer additive.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Many different materials may be used to create components for a lithium-ion battery. For example, in various aspects, positive electrodes include nickel-rich electroactive materials (e.g., greater than or equal to about 0.6 mole fraction on transition metal lattice), such as NMC (LiNi_{1-x-y}CoₓMn_{y}O₂) (where 0.10≤x≤0.33, 0.10≤y≤0.33) or NCMA (LiNi_{1-x-y-z}CoₓMn_{y}Al_{z}O₂) (where 0.02≤x≤0.20, 0.01≤y≤0.12, 0.01≤z≤0.08), which are capable of providing improved capacity capability (e.g., greater than 200 mAh/g) while allowing for additional lithium extraction without compromising the structural stability of the positive electrode. Such materials, however, have high surface reactivities, and as such, are often susceptible to material loss, for example, resulting from reactions with ambient CO₂ and/or H₂O during formation of the positive electrode and/or chemical oxidation of the electrolyte during battery operation. These reactions are often exothermic and commonly impact the thermostability and longevity of battery cells, for example, additional transport resistance may be caused by Li₂CO₃/LiOH films formed on surfaces of the nickel-rich electroactive material when reacted with ambient CO₂ and/or H₂O during formation. Accordingly, it would be desirable to develop improved electrodes and electroactive materials, and methods of using the same, that can address these challenges.

### SUMMARY

This section provides a general summary of the disclosure, and is not a comprehensive disclosure of its full scope or all of its features.

The present disclosure relates to positive electrode or cathode materials, and in particular, additives for positive electrodes, and methods of making and using the same.

In various aspects, the present disclosure provides an electrode for use in an electrochemical cell that cycles lithium ions. The electrode may include a high-nickel electroactive material having greater than or equal to about 0.6 mole fraction of nickel, and greater than or equal to about 0.1 wt. % to less than or equal to about 2 wt. % of a sulfonated aromatic ionomer additive.

In one aspect, the high-nickel electroactive material may be represented by:

LiM¹ₓM²_{y}M³_{z}M⁴_{(1-x-y-z)}O₂

where at least one of M¹, M², M³, and M⁴ is nickel (Ni) and the remaining members of M¹, M², M³, and M⁴ are transitions metals independently selected from the group consisting of: manganese (Mn), cobalt (Co), aluminum (Al), iron (Fe), and combinations thereof, and where 0≤x≤1, 0≤y≤1, and 0≤z≤1.

In one aspect, the high-nickel electroactive material may be selected from the group consisting of NMC (LiNi_{1-x-y}CoₓMn_{y}O₂) (where 0≤x≤1 and 0≤y≤1), NCMA (LiNi_{1-x-y-z}CoₓMn_{y}Al_{z}O₂) (where 0≤x≤1, 0≤y≤1, and 0≤z≤1), NCA (LiNi_{1-x-y}CoₓAl_{y}O₂, where 0≤x≤1 and 0≤y≤1), LNMO (LiNiₓMn₁₋ₓO₂, where 0≤x≤1) and combinations thereof.

In one aspect, the electrode may further include a second electroactive material. The second electroactive material may be selected from the group consisting of: lithium manganese oxide (Li₍₁₊ₓ₎Mn₂O₄, where 0.1≤x≤1) (LMO), lithium nickel manganese oxide (LiNi_{0.5}Mn_{1.5}O₄), lithium cobalt oxide (LiCoO₂) (LCO), lithium iron phosphate (LiFePO₄), lithium vanadium phosphate (LiVPO₄), lithium manganese iron phosphate (LiMn₁₋ₓFeₓPO₄, where 0≤x≤1), and combinations thereof.

In one aspect, the electrode may include greater than or equal to about 45 wt. % to less than or equal to about 99 wt. % of the high-nickel electroactive material, and greater than 0 wt. % to less than or equal to about 49.5 wt. % of the second electroactive material.

In one aspect, the sulfonated aromatic ionomer additive may include a sulfonated derivate of poly(arylene ether) (SPAE), poly(arylene ether sulfone) (SPAES), poly(arylene sulfide) (SPAS), sulfonated polyimide (SPI), sulfonated polyphenylene (SPP), and combinations thereof, and one or more cations selected from H⁺, Li⁺, Na⁺, K⁺, and NH₄⁺.

In one aspect, the electrode may further include greater than or equal to about 1 wt. % to less than or equal to about 10 wt. % of a binder.

In one aspect, the binder may have a molecular weight greater than or equal to about 200 kilodaltons (kD) to less than or equal to about 2000 kilodaltons (kD).

In one aspect, the binder may be selected from the group consisting of: polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, and combinations thereof.

In one aspect, the electrode may further include greater than or equal to about 0.5 wt. % to less than or equal to about 10 wt. % of an electronically conductive material.

In one aspect, the electronically conductive material may include greater than or equal to about 0.25 wt. % to less than or equal to about 10 wt. % of carbon black or acetylene black, greater than or equal to about 0.1 wt. % to less than or equal to about 10 wt. % of graphene nanoplatelets, and greater than or equal to about 0.05 wt. % to less than or equal to about 2 wt. % of carbon nanotubes.

In various aspects, the present disclosure provides a method for preparing an electrode for use in an electrochemical cell that cycles lithium ions. The method may include contacting an electroactive material slurry with one or more surfaces of a current collector, where a solids portion of the slurry includes greater than or equal to about 45 wt. % to less than or equal to about 99 wt. % of a high-nickel electroactive material, and greater than or equal to about 0.1 wt. % to less than or equal to about 2 wt. % of a sulfonated aromatic ionomer additive. The high-nickel electroactive material may have greater than or equal to about 0.6 mole fraction of nickel.

In one aspect, the solids portion of the slurry may further include greater than or equal to about 1 wt. % to less than or equal to about 10 wt. % of a binder. The binder may have a molecular weight greater than or equal to about 200 kilodaltons (kD) to less than or equal to about 2000 kilodaltons (kD).

In one aspect, the solids portion of the slurry may further include greater than or equal to about 0.5 wt. % to less than or equal to about 10 wt. % of an electronically conductive material.

In one aspect, the electronically conductive material may include greater than or equal to about 0.25 wt. % to less than or equal to about 10 wt. % of carbon black or acetylene black, greater than or equal to about 0.1 wt. % to less than or equal to about 10 wt. % of graphene nanoplatelets, and greater than or equal to about 0.05 wt. % to less than or equal to about 2 wt. % of carbon nanotubes.

In one aspect, the high-nickel electroactive material may be selected from the group consisting of NMC (LiNi_{1-x-y}CoₓMn_{y}O₂) (where 0≤x≤1 and 0≤y≤1), NCMA (LiNi_{1-x-y-z}CoₓMn_{y}Al_{z}O₂) (where 0≤x≤1, 0≤y≤1, and 0≤z≤1), NCA (LiNi_{1-x-y}CoₓAl_{y}O₂, where 0≤x≤1 and 0≤y≤1), LNMO (LiNiₓMn₁₋ₓO₂, where 0≤x≤1) and combinations thereof.

In one aspect, the electrode may further include greater than 0 wt. % to less than or equal to about 49.5 wt. % of a second electroactive material. The second electroactive material may be selected from the group consisting of: lithium manganese oxide (Li₍₁₊ₓ₎Mn₂O₄, where 0.1≤x≤1) (LMO), lithium nickel manganese oxide (LiNi_{0.5}Mn_{1.5}O₄), lithium cobalt oxide (LiCoO₂, LCO), lithium iron phosphate (LiFePO₄), lithium vanadium phosphate (LiVPO₄), lithium manganese iron phosphate (LiMn₁₋ₓFeₓPO₄, where 0≤x≤1), and combinations thereof.

In one aspect, the sulfonated aromatic ionomer additive may include a sulfonated derivate of poly(arylene ether) (SPAE), poly(arylene ether sulfone) (SPAES), poly(arylene sulfide) (SPAS), sulfonated polyimide (SPI), sulfonated polyphenylene (SPP), and combinations thereof, and one or more cations selected from H⁺, Li⁺, Na⁺, K⁺, and NH₄⁺.

In one aspect, the slurry may further include a solvent. The solvent may be selected from the group consisting of: N-methyl pyrrolidone (NMP), dimethylacetamide (DMAc), dimethylformamide (DMF), dimethyl sulfoxide (DMSO) and combinations thereof. The solvent may include greater than or equal to about 20% to less than or equal to about 50% of a weight of the slurry.

In one aspect, the method may further include preparing the electroactive material slurry by contacting the high-nickel electroactive material and the sulfonated aromatic ionomer additive with a solvent.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical battery cell prepared in accordance with various aspects of the present disclosure;

FIG. 2 is a flowchart illustrating an example method for forming a positive electrode, for example a positive electrode for use in the example electrochemical battery cell illustrated in FIG. 1, in accordance with various aspects of the present disclosure;

FIG. 3A is a graphical illustration demonstrating the capacity retention of an example battery cell including a sulfonated aromatic ionomer additive in accordance with various aspects of the present disclosures;

FIG. 3B is a graphical illustration demonstrating the internal resistance of an example battery cell including a sulfonated aromatic ionomer additive in accordance with various aspects of the present disclosures;

FIG. 4A is a graphical illustration demonstrating the shear rate hysteresis of a first particle dispersion including a high-nickel electroactive material, an electronically conductive material, and a binder;

FIG. 4B is a graphical illustration demonstrating the shear rate hysteresis of a second particle dispersion including a high-nickel electroactive material, an electronically conductive material, a binder, and a sulfonated aromatic ionomer additive;

FIG. 5A is a graphical illustration demonstrating the shear rate hysteresis of a first particle dispersion including an electronically conductive material and a binder;

FIG. 5B is a graphical illustration demonstrating the shear rate hysteresis of a second particle dispersion including an electronically conductive material, a binder, and a polyvinyl-4-pyridine (PVPy) additive; and

FIG. 5C is a graphical illustration demonstrating the shear rate hysteresis of a third particle dispersion including an electronically conductive material, a binder, and a sulfonated aromatic ionomer additive.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

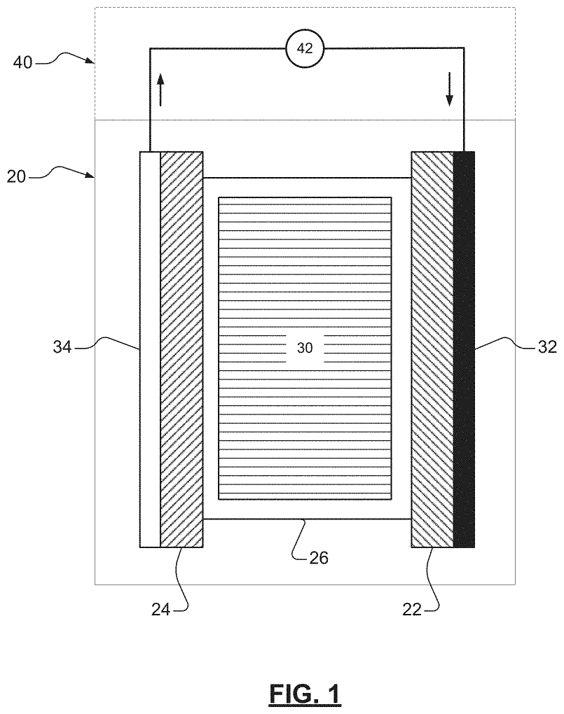

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 may be a metal foil, metal grid or screen, or expanded metal comprising copper or any other appropriate electronically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electronically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

In various aspects, the separator 26 may be a microporous polymeric separator. The microporous polymeric separator may include, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of polyethylene (PE) and/or polypropylene (PP). Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm. The separator 26 may have an average thickness greater than or equal to 1 μm to less than or equal to 50 μm, and in certain instances, optionally greater than or equal to 1 μm to less than or equal to 20 μm.

In each variation, the separator 26 may further include one or more ceramic materials and/or one or more heat-resistant materials. For example, the separator 26 may also be admixed with the one or more ceramic materials and/or the one or more heat-resistant materials, or one or more surfaces of the separator 26 may be coated with the one or more ceramic materials and/or the one or more heat-resistant materials. The one or more ceramic materials may include, for example, alumina (Al₂O₃), silica (SiO₂), and the like. The heat-resistant material may include, for example, Nomex, Aramid, and the like.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof.

The negative electrode 22 may be formed from a lithium host material that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. In certain variations, the negative electrode 22 may include a plurality of solid-state electrolyte particles (not shown). The negative electrode 22 may have an average thickness greater than or equal to about 1 μm to less than or equal to about 500 μm, and in certain aspects, optionally greater than or equal to about 10 μm to less than or equal to about 200 μm. The negative electrode 22 may have an average thickness greater than or equal to 1 μm to less than or equal to 500 μm, and in certain aspects, optionally greater than or equal to 10 μm to less than or equal to 200 μm.

The negative electrode 22 may include a negative electroactive material that comprises lithium, such as, for example, lithium metal. In certain variations, the negative electrode may be a film or layer formed of lithium metal. Other materials can also be used to form the negative electrode 22, including, for example, carbonaceous materials (such as, graphite, hard carbon, soft carbon), and/or lithium-silicon, silicon containing binary and ternary alloys, and/or tin-containing alloys (such as, Si, Li—Si, SiOₓ (where 0≤x≤2), Si—Sn, SiSnFe, SiSnAl, SiFeCo, SnO₂, and the like), and/or other volume-expanding materials (e.g., aluminum (Al), germanium (Ge)). For example, in certain variations, the negative electroactive material may include a carbonaceous-silicon based composite including, for example, about 10 wt. % SiOₓ (where 0≤x≤2) and about 90 wt. % graphite.

In certain variations, the negative electroactive material(s) in the negative electrode 22 may be optionally intermingled with one or more electronically conductive materials that provide an electron conductive path and/or at least one polymeric binder material that improves the structural integrity of the negative electrode 22. For example, the negative electroactive material(s) in the negative electrode 22 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electronically conducting materials may include carbon-based materials, powdered nickel or other metal particles, or a conductive polymer. Carbon-based materials may include, for example, particles of graphite, acetylene black (such as DENKA™ black), carbon black (such as KETCHEN™ black and/or Super C45 or C65), carbon fibers and nanotubes, graphene, and the like. Examples of a conductive polymer include polyaniline, polythiophene, polyacetylene, polypyrrole, and the like. In certain aspects, mixtures of the conductive materials may be used.

The negative electrode 22 may include greater than or equal to about 10 wt. % to less than or equal to about 99 wt. %, and in certain variations, greater than or equal to about 50 wt. % to less than or equal to about 95 wt. %, of the negative electroactive material(s); greater than or equal to 0 wt. % to less than or equal to about 40 wt. %, and in certain aspects, optionally greater than or equal to about 1 wt. % to less than or equal to about 20 wt. %, of the electronically conducting material; and greater than or equal to 0 wt. % to less than or equal to about 40 wt. %, and in certain aspects, optionally greater than or equal to about 1 wt. % to less than or equal to about 20 wt. %, of the at least one polymeric binder.

The negative electrode 22 may include greater than or equal to 10 wt. % to less than or equal to 99 wt. %, and in certain variations, greater than or equal to 50 wt. % to less than or equal to 95 wt. %, of the negative electroactive material(s); greater than or equal to 0 wt. % to less than or equal to 40 wt. %, and in certain aspects, optionally greater than or equal to 1 wt. % to less than or equal to 20 wt. %, of the electronically conducting material; and greater than or equal to 0 wt. % to less than or equal to 40 wt. %, and in certain aspects, optionally greater than or equal to 1 wt. % to less than or equal to 20 wt. %, of the at least one polymeric binder.

The positive electrode 24 may be formed from a lithium-based active material that is capable of undergoing lithium intercalation and deintercalation, alloying and dealloying, or plating and stripping, while functioning as the positive terminal of the battery 20. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. For example, in certain variations, the positive electrode 24 may include a plurality of solid-state electrolyte particles (not shown). In each instance, the positive electrode 24 may have a thickness greater than or equal to about 1 μm to less than or equal to about 500 μm, and in certain aspects, optionally greater than or equal to about 10 μm to less than or equal to about 200 μm. The positive electrode 24 may have a thickness greater than or equal to 1 μm to less than or equal to 500 μm, and in certain aspects, optionally greater than or equal to 10 μm to less than or equal to 200 μm.

One exemplary common class of known materials that can be used to form the positive electrode 24 is layered lithium transitional metal oxides. For example, in certain aspects, the positive electrode 24 may comprise one or more materials having a spinel structure, such as lithium manganese oxide (Li₍₁₊ₓ₎Mn₂O₄, where 0.1≤x≤1) (LMO), lithium manganese nickel oxide (LiMn₍₂₋ₓ₎NiₓO₄, where 0≤x≤0.5) (LNMO) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤0.9, 0≤y≤0.33, 0≤z≤0.33, and x+y+z=1) (e.g., LiMn_{0.33}Ni_{0.33}Co_{0.33}O₂) (NMC), or a lithium nickel cobalt metal oxide (LiNi_{(1-x-y)}CoₓM_{y}O₂, where 0≤x≤0.2, y≤0.2, and M may be Al, Mg, Ti, or the like); or a lithium iron polyanion oxide with olivine structure, such as lithium iron phosphate (LiFePO₄) (LFP), lithium manganese-iron phosphate (LiMn₂₋ₓFeₓPO₄, where 0<x<0.3) (LFMP), or lithium iron fluorophosphate (Li₂FePO₄F).

In various aspects, the positive electrode 24 may be a nickel-rich cathode represented by:

LiM¹ₓM²_{y}M³_{z}M⁴_{(1-x-y-z)}O₂

where at least one of M¹, M², M³, and M⁴ is nickel (Ni) and the remaining members of M¹, M², M³, and M⁴ are transitions metals independently selected from the group consisting of: nickel (Ni), manganese (Mn), cobalt (Co), aluminum (Al), iron (Fe), and combinations thereof) and where 0≤x≤1, 0≤y≤1, and 0≤z≤1. For example, the positive electrode 24 may include NMC (LiNi_{1-x-y}CoₓMn_{y}O₂) (where 0≤x≤0.33 and 0≤y≤0.33) and/or NCMA (LiNi_{1-x-y-z}CoₓMn_{y}Al_{z}O₂) (where 0≤x≤0.9, 0≤y≤0.2, and 0≤z≤0.2) and/or NCA (LiNi_{1-x-y}CoₓAl_{y}O₂, where 0≤x≤1 and 0≤y≤1), LNMO (LiNiₓMn₁₋ₓO₂, where 0≤x≤1). More particularly, in certain variations, the positive electrode 24 may include one or more positive electroactive materials selected from NCM 111, NCM 532, NCM 622, NCM 712, NCM 811, NCA, LNMO, and combinations thereof. In such instances (i.e., positive electrodes having high nickel content (e.g., greater than or equal to about 0.6 mole fraction on transition metal lattice)), the positive electrode 24 may further include a sulfonated aromatic ionomer additive. For example, the positive electrode 24 may include greater than or equal to about 0.1 wt. % to less than or equal to about 2 wt. % of the sulfonated aromatic ionomer additive.

The positive electrode 24 may further include an electronically conducting material that provides an electron conduction path and/or a polymeric binder material that improves the structural integrity of the electrode 24. For example, the positive electrode 24 may include greater than or equal to about 5 wt. % to less than or equal to about 99 wt. %, optionally greater than or equal to about 10 wt. % to less than or equal to about 99 wt. %, and in certain variations, greater than or equal to about 50 wt. % to less than or equal to about 98 wt. %, of the positive electroactive material(s); greater than or equal to 0 wt. % to less than or equal to about 40 wt. %, and in certain aspects, optionally greater than or equal to about 1 wt. % to less than or equal to about 20 wt. %, of the electronically conducting material; and greater than or equal to 0 wt. % to less than or equal to about 40 wt. %, and in certain aspects, optionally greater than or equal to about 1 wt. % to less than or equal to about 20 wt. %, of the at least one polymeric binder. The positive electrode 24 may include greater than or equal to 5 wt. % to less than or equal to 99 wt. %, optionally greater than or equal to 10 wt. % to less than or equal to 99 wt. %, and in certain variations, greater than or equal to 50 wt. % to less than or equal to 98 wt. %, of the positive electroactive material(s); greater than or equal to 0 wt. % to less than or equal to 40 wt. %, and in certain aspects, optionally greater than or equal to 1 wt. % to less than or equal to 20 wt. %, of the electronically conducting material; and greater than or equal to 0 wt. % to less than or equal to 40 wt. %, and in certain aspects, optionally greater than or equal to 1 wt. % to less than or equal to 20 wt. %, of the at least one polymeric binder.

The positive electroactive material(s) in the positive electrode 24 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium. In certain variations, the binder may be a high molecular weight binder. For example, the binder may have a molecular weight greater than or equal to about 200 kilodaltons (kD) to less than or equal to about 2000 kilodaltons (kD).

The positive electroactive material(s) in the positive electrode 24 may be optionally intermingled (e.g., slurry casted) with electronically conducting materials like carbon-based materials, powdered nickel or other metal particles, or a conductive polymer. Carbon-based materials may include, for example, particles of graphite, acetylene black (such as DENKA™ black), carbon black (such as KETJEN™ black and/or Super C45 or C65), carbon fibers and nanotubes, graphene, and the like. Examples of a conductive polymer include polyaniline, polythiophene, polyacetylene, polypyrrole, and the like.

In certain variations, the positive electrode 24 may include a combination of electronically conducting materials. For example, the positive electrode 24 may include greater than or equal to about 0.25 wt. to less than or equal to about 10, and in certain aspects, optionally greater than or equal to about 0.5 wt. to less than or equal to about 5 wt. %, of a first electronically conducting material; greater than or equal to about 0.1 wt. to less than or equal to about 10 wt. %, and in certain aspects, optionally greater than or equal to about 0.5 wt. to less than or equal to about 5 wt. %, of a second electronically conducting material; and greater than or equal to about 0.05 wt. to less than or equal to about 2 wt. %, and in certain aspects, optionally greater than or equal to about 0.05 wt. to less than or equal to about 1 wt. %, of a third electronically conducting material. The positive electrode 24 may include greater than or equal to 0.25 wt. to less than or equal to 10, and in certain aspects, optionally greater than or equal to 0.5 wt. to less than or equal to 5 wt. %, of a first electronically conducting material; greater than or equal to 0.1 wt. to less than or equal to 10 wt. %, and in certain aspects, optionally greater than or equal to 0.5 wt. to less than or equal to 5 wt. %, of a second electronically conducting material; and greater than or equal to 0.05 wt. to less than or equal to 2 wt. %, and in certain aspects, optionally greater than or equal to 0.05 wt. to less than or equal to 1 wt. %, of a third electronically conducting material. In one variation, the first electronically conducting material may be carbon black or acetylene black, the second electronically conducting material may be graphene nanoplatelets, and the third electronically conducting material may be carbon nanotubes.

In each variation, the sulfonated aromatic ionomer additive may include sulfonated derivates of poly(arylene ether) (SPAE), poly(arylene ether sulfone) (SPAES), poly(arylene sulfide) (SPAS), sulfonated polyimide (SPI), sulfonated polyphenylene (SPP), and combinations thereof. For example, in certain variations, the sulfonated derivate may be a sulfonated phenylated polyphenylene (sPPP). The sulfonated derivative may be used with one or more cations, such as H⁺, Li⁺, Na⁺, K⁺, NH⁴⁺. For example, in certain variations, a sulfonic acid form sPPP-H, such as depicted below, may be used.

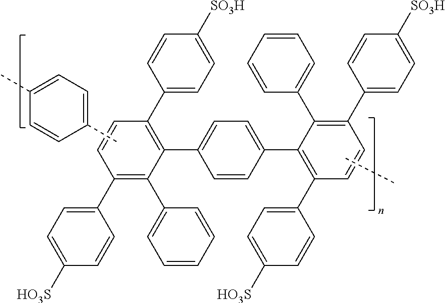

In each variation, the sulfonated aromatic ionomer additive may adsorb (e.g., via its acid moiety) on the surface of the nickel-rich electroactive material thereby mitigating formation of by Li₂CO₃/LiOH films during preparation of the positive electrode 24. For example, the sulfonated aromatic ionomer additive may be adsorbed on the surface of the nickel-rich electroactive material following lithium ion exchange, thereby physically blocking the formation of Li₂CO₃/LiOH. Further, in various aspects, the sulfonated aromatic ionomer additive may have a high affinity to and adsorb on carbon surfaces, for example, via π-orbital bonding, during formation of the positive electrode 24, which can help to provide electrosteric stability against agglomerate formation, and as such, more uniformed distribution of conductive carbon in the positive electrode 24.

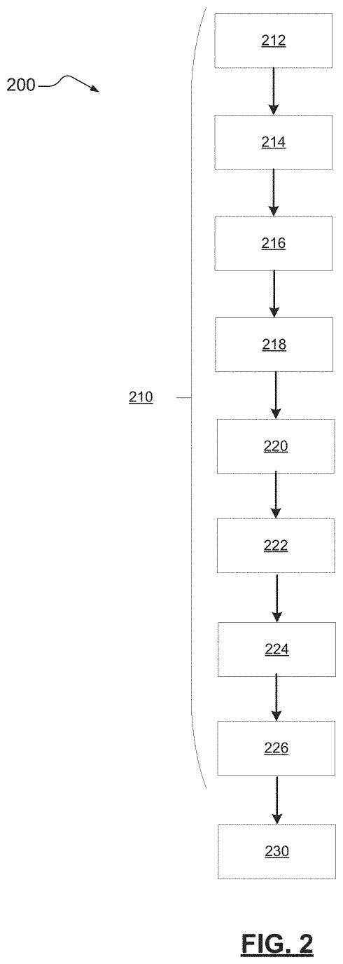

In various aspects, the present disclosure provides methods for preparing a positive electrode, like the positive electrode 24 illustrated in FIG. 1. For example, FIG. 2 illustrates an example method 200 for preparing a positive electrode, like the positive electrode 24 illustrated in FIG. 1. The method 200 may include contacting 230 a positive electrode or cathode material slurry with one or more surfaces of a positive electrode current collector (e.g., aluminum current collector). The contacting 230 may include coating the one or more surfaces of the positive electrode current collector using, for example, a doctor blade or an automatic coater, by way of non-limiting example.

The cathode material slurry includes a positive electroactive material. In certain variations, the positive electroactive material may be a blended material including, for example, a high-nickel positive electroactive material (e.g., NCMA (LiNi_{1-x-y-z}CoₓMn_{y}Al_{z}O₂) (where 0.02≤x≤0.20, 0.01≤y≤0.12, 0.01≤z≤0.06)) and another positive electroactive material (e.g., lithium manganese oxide (Li₍₁₊ₓ₎Mn₂O₄, where 0.1≤x≤1) (LMO), lithium nickel manganese oxide (LiNi_{0.5}Mn_{1.5}O₄), lithium cobalt oxide (LiCoO₂) (LCO), lithium iron phosphate (LiFePO₄), lithium vanadium phosphate (LiVPO₄), and/or lithium manganese iron phosphate (LiMn₁₋ₓFeₓPO₄, where 0≤x≤1)). The slurry further includes a sulfonated aromatic ionomer additive (e.g., sPPP-H) and a solvent (e.g., N-methyl pyrrolidone (NMP)). The slurry may also include one or more binders (e.g., polyvinylidene fluoride (PVdF)) and/or one or more electronically conductive materials. (e.g., carbon black (CB), acetylene black, graphene nanoplatelets (GNP), and/or single-wall carbon nanotubes (SWCNT)).

For example, in various aspects, the solids portion of the slurry may include greater than or equal to about 80 wt. % to less than or equal to about 98 wt. % of the positive electroactive material (including, for example, greater than or equal to about 50 wt. % to less than or equal to about 100 wt. % of the high-nickel positive electroactive material and greater than or equal to about 0 wt. % to less than or equal to about 50 wt. % of the another positive electroactive material), greater than or equal to about 0.1 wt. % to less than or equal to about 2 wt. % of the sulfonated aromatic ionomer additive, greater than or equal to about 1 wt. % to less than or equal to about 10 wt. % of the one or more binders, and greater than or equal to about 1 wt. % to less than or equal to about 10 wt. % of the one or more electronically conductive materials (including, for example, greater than or equal to about 0.5 wt. % to less than or equal to about 5 wt. % of carbon black or acetylene black, greater than or equal to about 0.5 wt. % to less than or equal to about 5 wt. % of graphene nanoplatelets, and greater than or equal to about 0.05 wt. % to less than or equal to about 1 wt. % of carbon nanotubes). The slurry may include greater than or equal to about 50% w/w to less than or equal to about 80% w/w of solids (i.e., the positive electroactive material(s), the sulfonated aromatic ionomer additive, the one or more binders, and the one or more electronically conductive material) in the solvent.

In certain variations, the solids portion of the slurry may include greater than or equal to 80 wt. % to less than or equal to 98 wt. % of the positive electroactive material (including, for example, greater than or equal to 50 wt. % to less than or equal to 100 wt. % of the high-nickel positive electroactive material and greater than or equal to 0 wt. % to less than or equal to 50 wt. % of the another positive electroactive material), greater than or equal to 0.1 wt. % to less than or equal to 2 wt. % of the sulfonated aromatic ionomer additive, greater than or equal to 1 wt. % to less than or equal to 10 wt. % of the one or more binders, and greater than or equal to 1 wt. % to less than or equal to 10 wt. % of the one or more electronically conductive materials (including, for example, greater than or equal to 0.5 wt. % to less than or equal to 5 wt. % of carbon black or acetylene black, greater than or equal to 0.5 wt. % to less than or equal to 5 wt. % of graphene nanoplatelets, and greater than or equal to 0.05 wt. % to less than or equal to 1 wt. % of carbon nanotubes). The slurry may include greater than or equal to 50% w/w to less than or equal to 80% w/w of solids (i.e., the positive electroactive material(s), the sulfonated aromatic ionomer additive, the one or more binders, and the one or more electronically conductive material) in the solvent.

In various aspects, the method 200 may further include preparing 210 the slurry. Preparing 210 the slurry may include concurrently or consecutively adding the positive electroactive material, the sulfonated aromatic ionomer additive, the one or more binders, and/or the one or more electronically conductive materials to the solvent and milling the combination using a planetary centrifugal mixer. The planetary centrifugal mixer may include zirconia beads having a diameter of about 3 mm (and in certain aspects, optionally 3 mm). In certain variations, preparing 210 the slurry may include adding 212 the one or more electronically conductive materials to the solvent and milling 214 the combination for a first time period (e.g., about 5 minutes, and in certain aspects, optionally 5 minutes) at a speed of about 2,000 rpm followed by a second time period (e.g., about 5 minutes, and in certain aspects, optionally 5 minutes). The separate first and second time periods helps ensure that the combination is maintained at about room temperature (e.g., greater than or equal to about 15° C. to less than or equal to about 40° C.) during the milling process.

Preparing 210 the slurry may further include adding the positive electroactive material to the solvent mixture including the one or more electronically conductive materials. For example, in certain variations, as illustrated, preparing 210 the slurry may include adding 216 a first positive electroactive material (e.g., the another positive electroactive material (e.g., lithium manganese oxide (Li₍₁₊ₓ₎Mn₂O₄, where 0.1≤x≤1) (LMO), lithium nickel manganese oxide (LiNi_{0.5}Mn_{1.5}O₄), lithium cobalt oxide (LiCoO₂) (LCO), lithium iron phosphate (LiFePO₄), lithium vanadium phosphate (LiVPO₄), and/or lithium manganese iron phosphate (LiMn₁₋ₓFeₓPO₄, where 0≤x≤1)) to the solvent mixture including the one or more electronically conductive materials, and mixing 218 the combination for a third time period (e.g., about 5 minutes, and in certain aspects, optionally 5 minutes); and then adding 220 a second positive electroactive material (e.g., the nickel-rich electroactive material (e.g., NCMA (LiNi_{1-x-y-z}CoₓMn_{y}Al_{z}O₂) (where 0.02≤x≤0.20, 0.01≤y≤0.12, 0.01≤z≤0.06)) to the solvent mixture including the one or more electronically conductive materials and the first positive electroactive material, and mixing 222 the combination for a fourth time period (e.g., about 5 minutes, and in certain aspects, optionally 5 minutes).

Preparing 210 the slurry may further include adding 224 the one or more binders and the sulfonated aromatic ionomer additive to the solvent mixture including the one or more electronically conductive materials and the positive electroactive material, and mixing 226 the combination for a fifth time period (e.g., about 5 minutes and in certain aspects, optionally 5 minutes). In each variation, the mixing 214, 218, 222, 225 may be conducted at a humidity below an about −5° C. dew point (preferably, greater than or equal to about −20° C. to less than or equal to about −10° C., and in certain aspects, optionally greater than or equal to −20° C. to less than or equal to −10° C.). The low humidity may be important of preventing or limiting the formation of Li₂CO₃/LiOH films on surfaces of the nickel-rich electroactive material. Likewise, although not illustrated, in each variation, prior to the adding 212, 116, 220, 224, the method 200 may including drying one or more of the materials—i.e., the one or more electronically conductive materials, the positive electroactive material, the one or more binders, and the sulfonated aromatic ionomer additive-prior to adding or dispersing in the solvent. For example, the material(s) may be vacuum dried at about 50° C. (and in certain aspects, optionally 50° C.) for at least about 24 hours (and in certain aspects, optionally 24 hours) prior to dispersing in the solvent.

In various aspects, the method 200 further includes drying 240 the as-applied slurry to form an electroactive material layer on or adjacent to the one or more surfaces of the current collector. In certain variations, drying 240 may include heating assembly to about 70° C. (and in certain aspects, optionally 70° C.) in air. The method 200 may also include calendaring 250 the assembly at room temperature to form an electroactive material layer having a porosity greater than or equal to about 25 vol. % to less than or equal to about 50 vol. %, and in certain aspects, optionally greater than or equal to 25 vol. % to less than or equal to 50 vol. %. Further still, in certain variations, the method 200 may include punching 260 the assembly to form a plurality of electrode coatings and drying 270 in vacuum oven, for example, at about 50° C. (and in certain aspects, optionally 50° C.) for about 12 hours (and in certain aspects, optionally 12 hours). In each variations, positive electrodes may be prepared having target areal capacities of about 5.0 mAh/cm² (and in certain aspects, optionally 5.0 mAh/cm²).

Certain features of the current technology are further illustrated in the following non-limiting examples.

### Example 1

Example battery cells may be prepared in accordance with various aspects of the present disclosure.

For example, in certain variations, a positive electrode may be prepared by contacting a positive electrode or cathode material slurry and one or more surfaces of a current collector. In each variation, the cathode material slurry may be prepared by dispersing a positive electroactive material, as well as one or more electronically conducting materials and/or one or more binders, in a solvent. A sulfonated aromatic ionomer additive (e.g., sPPP-H) may also be dispersed in the solvent. The solvent may be, for example, N-methyl pyrrolidone (NMP), which may be formulated at greater than or equal to about 25% to less than or equal to about 40%, and in certain aspects, optionally greater than or equal to 25% to less than or equal to 40%, of the slurry weight. As summarized in the following table, the positive electroactive material may include a blend of a nickel-rich electroactive material (e.g., NCMA (LiNi_{1-x-y-z}CoₓMn_{y}Al_{z}O₂) (where 0.02≤x≤0.20, 0.01≤y≤0.12, 0.01≤z≤0.06)) and another positive electroactive material (e.g., lithium manganese oxide (Li₍₁₊ₓ₎Mn₂O₄, where 0.1≤x≤1) (LMO)).

| Property | NCMA | LMO |
|---|---|---|
| Grade | S92EA-DX | MSL-25B |
| Composition | LiNi_{0.9}Co_{0.05}Mn_{0.03}Al_{0.02}O₂ | LiMn₂O₄ |
| Particle Size D50 | 11 | 12.4 |
| (μm) | | |
| Surface Area (m²/g) | 0.46 | 0.57 |
| Tap Density (g/cm³) | 2.61 | 2.12 |
| Specific Capacity | 209 | 108 |
| @ C/10 (mAh/g) | | |
| Surface Coatings | N/A | Alumina |

As summarized in the following table, the one or more electronically conducting materials may include carbon black (CB), graphene nanoplatelets (GNP), and single-wall carbon nanotubes (SWCNT).

| | | Graphene | |
|---|---|---|---|
| Property | Carbon Black | Nanoplatelets | Carbon Nanotubes |
| Grade | SuperP-Li | R-7 | Tuball BATT NMP |
| Composition | Carbon Powder | Carbon Powder | 0.4% SW-CNT |
| | | | 2% Solef 5130 |
| | | | 97.6% NMP |
| Diameter (nm) | 40 | 7,000 | 1.6 |
| Surface Area (m²/g) | 65 | 65 | 1300 |
| Tap Density (g/cm³) | 0.016 | 0.08 | 0.035 |
| Aspect Ratio | ~1-2 | ~450 | ~3000 |

The one or more binders may include an ultra-high molecular weight (e.g., M_{w}>1000 kD) polyvinyl difluoride (PVDF) homopolymer. In summary, the cathode slurry may include the following solids composition.

| Material | Solids (wt. %) |
|---|---|
| Electroactive Material | 80-99 |
| PVDF Homopolymer/Copolymer Blend | 1-10 |
| Aromatic Ionomer Additive | 0.2-2 |
| Carbon Black | 0.5-5 |
| Graphene Nanoplatelets | 0.5-5 |
| Carbon Nanotubes | 0.05-1 |

The positive electroactive material, the one or more electronically conductive materials, the one or more binders, and the sulfonated aromatic ionomer additive may be added to the solvent concurrently or consecutively. In certain variations, the positive electrode slurry may be mixed using a centrifugal mixture that includes zirconia beads having a diameter of about 3 mm (and in certain aspects, optionally 3 mm). In one variation, the one or more electronically conductive materials (e.g., carbon black (CB), graphene nanoplatelets (GNP), and/or single-wall carbon nanotubes (SWCNT)) may be added to and mixed with the solvent for about 10 minutes (and in certain aspects, optionally 10 minutes) at about 2000 rpm (and in certain aspects, optionally 2000 rpm), pausing after about 5 minutes (and in certain aspects, optionally 5 minutes) so the combination is maintained at about room temperature.

Thereafter, the another positive electroactive material (e.g., lithium manganese oxide (Li₍₁₊ₓ₎Mn₂O₄, where 0.1≤x≤1) (LMO)) may be added, along with some additional solvent, and the combination mixed for about 5 more minutes (and in certain aspects, optionally 5 more minutes).

Afterwards, the nickel-rich electroactive material (e.g., NCMA (LiNi_{1-x-y-z}CoₓMn_{y}Al_{z}O₂) (where 0.02≤x≤0.20, 0.01≤y≤0.12, 0.01≤z≤0.06), along with some additional solvent, may be added and the combination may be mixed for about 5 more minutes (and in certain aspects, optionally 5 more minutes).

Finally, the one or more binders and the sulfonated aromatic ionomer additive may be added, along with some additional solvent, and the combination mixed for about 5 more minutes (and in certain aspects, optionally 5 more minutes). In each variation, the mixing may be conducted at a humidity below an about −5° C. dew point (preferably, greater than or equal to about −20° C. to less than or equal to about −10° C., and in certain aspects, optionally greater than or equal to about −20° C. to less than or equal to about −10° C.). The low humidity is important of preventing or limiting the formation of Li₂CO₃/LiOH films on surfaces of the nickel-rich electroactive material.

An example cell 310 may be prepared by combining the positive electrode, as prepared, with a graphite anode having, for example, a loading of about 5.5 mAh/cm², such that the cells have an N/P ratio of about 1.1. The example cell 310 may also include an electrolyte (e.g., 1M lithium hexafluorophosphate (LiPF₆) in a solvent mixture) and a separator. The solvent mixture may include ethylene carbonate (EC): ethyl methyl carbonate (EMC) (e.g., 3:7 w/w solvent mixture), and also, about 2.0 wt. % of vinylene carbonate (VC) solvent. The example cell 310 may undergo two formation cycles at a charge rate of C/20 with a constant current-constant voltage hold of C/50 and a constant current discharge rate of C/20. A comparative battery cell 320 may be similarly prepared, but omits the sulfonated aromatic ionomer additive.

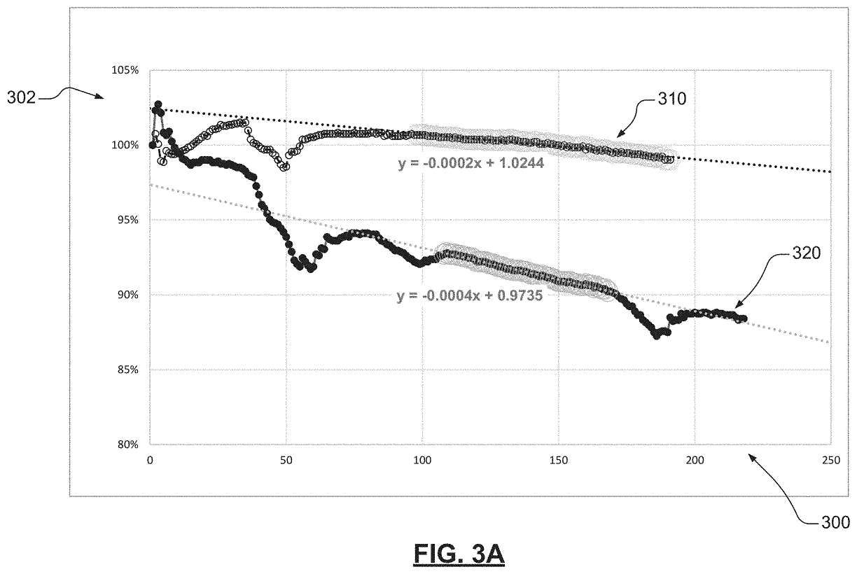

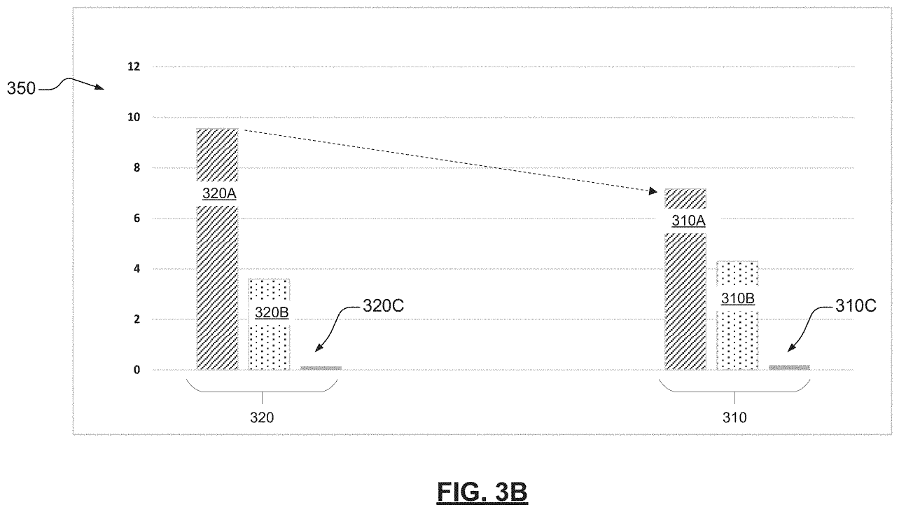

FIG. 3A is a graphical illustration representing the capacity retention of the example battery cell 310, as compared to the comparative battery cell 320, where the x-axis 300 represents cycle numbers, and the y-axis 302 represents capacity retention (%). As illustrated, after 200 cycles, the example battery cell 310 prepared in accordance with various aspects of the present disclosure has improved long term performance as compared to the comparative battery cell 320. As illustrated, the example battery cell 310 has about a two times lower retention loss rate as compared to the comparative battery cell 320 and about a 10% improvement in charge capacity after 200 cycles.

FIG. 3B is a graphical illustration representing the internal resistance of the example battery cell 310, as compared to the comparative battery cell 320, where the y-axis 350 represents internal electrode resistance (Ω·cm²). As illustrated, the example battery cell 310 has improved pore channel resistance (i.e., the pore channel resistance (R) for lithium ion (Li⁺) transport through the electrode), as compared to the comparative battery 320. The improvement can be attributed to the more uniform distribution of the binder polymer that results from the incorporation of the sulfonated aromatic ionomer additive. Since the sulfonated aromatic ionomer additive mitigates surface formation of a LiCO₃/LiOH on the electroactive particles (e.g., NCMA particles), and as such, favors an agglomerate growth, the electroactive particles are better dispersed in the coating slurry enabling the binder polymer to permeate the electrode pore volume more evenly when the solvent is dried.

### Example 2

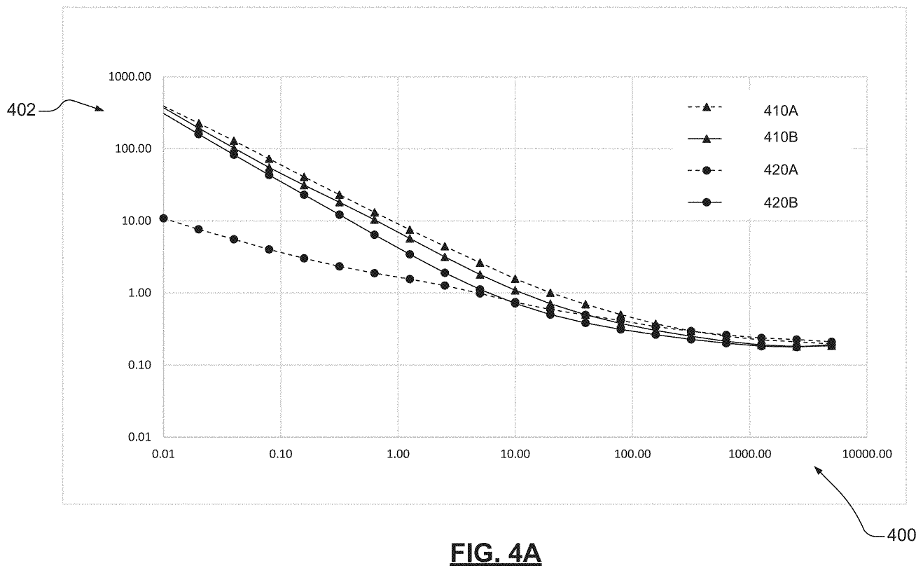

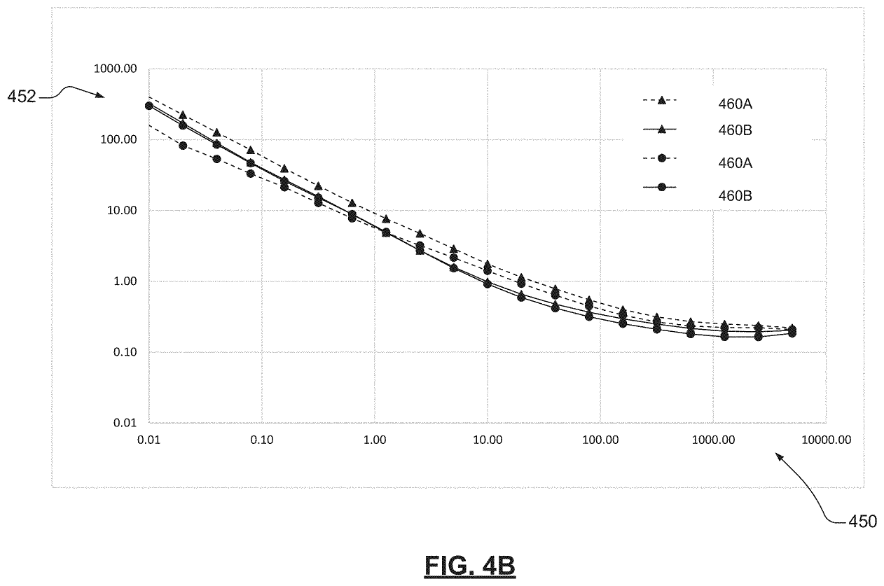

A first particle dispersion is prepared that represents a cathode material slurry to be used in the preparation of a positive electrode. The first particle dispersion includes NCMA (LiNi_{1-x-y-z}CoₓMn_{y}Al_{z}O₂) (where 0.02≤x≤0.20, 0.01≤y≤0.12, 0.01≤z≤0.06), an electronically conductive material (e.g. Super P), a binder (e.g., polyvinylidene fluoride (PVdF)), and a solvent (e.g., N-methyl pyrrolidone (NMP). FIG. 4A is a graphical illustration representing the dispersion stability after a two-day hold (up ramp 410A, down ramp 410B) at about 35% relative humidity, where there is no hysteresis in the fresh slurry (see the four-hour hold (up ramp 420A, down ramp 420B) at about 35% relative humidity. The x-axis 400 represents applied shear rate (1/sec). The y-axis 402 represents the measured viscosity (Pa·s). As illustrated, the aged dispersion (i.e., after the two-day hold) shows a viscosity in the up-ramp resulting from spheroidal agglomerate formation, which is re-dispersed at high applied shear-rate before the down-ramp. This illustrates the sensitivity of the high nickel content positive electroactive material (e.g., NCMA (LiNi_{1-x-y-z}CoₓMn_{y}Al_{z}O₂) (where 0.02≤x≤0.20, 0.02≤y≤0.12, 0.01≤z≤0.06) to water vapor exposure.

In comparison, a second particle dispersion is prepared that represents another cathode material slurry to be used in the preparation of a positive electrode. The second particle dispersion includes NCMA (LiNi_{1-x-y-z}CoₓMn_{y}Al_{z}O₂) (where 0.02≤x≤0.20, 0.02≤y≤0.12, 0.01≤z≤0.06) an electronically conductive material (e.g. Super P), a binder (e.g., polyvinylidene fluoride (PVdF)), and a solvent (e.g., N-methyl pyrrolidone (NMP), as well as a sulfonated aromatic ionomer additive (e.g., sPPP-H) in accordance with various aspects of the present disclosure. FIG. 4B is a graphical illustration representing the dispersion stability after a two-day hold (up ramp 460A, down ramp 460B) at about 35% relative humidity, where there is no hysteresis in the fresh slurry (see the four-hour hold (up ramp 470A, down ramp 470B) at about 35% relative humidity. The x-axis 450 represents applied shear rate (1/sec). The y-axis 452 represents measured viscosity (Pa-s). As illustrated, the aged dispersion (i.e., after the two-day hold) shows no significant hysteresis in the up versus down shear rate ramps. This indicates that the sulfonated aromatic ionomer additive helps to prevent or limit the formation of Li₂CO₃/LiOH films on the high-nickel positive electroactive material.

### Example 3

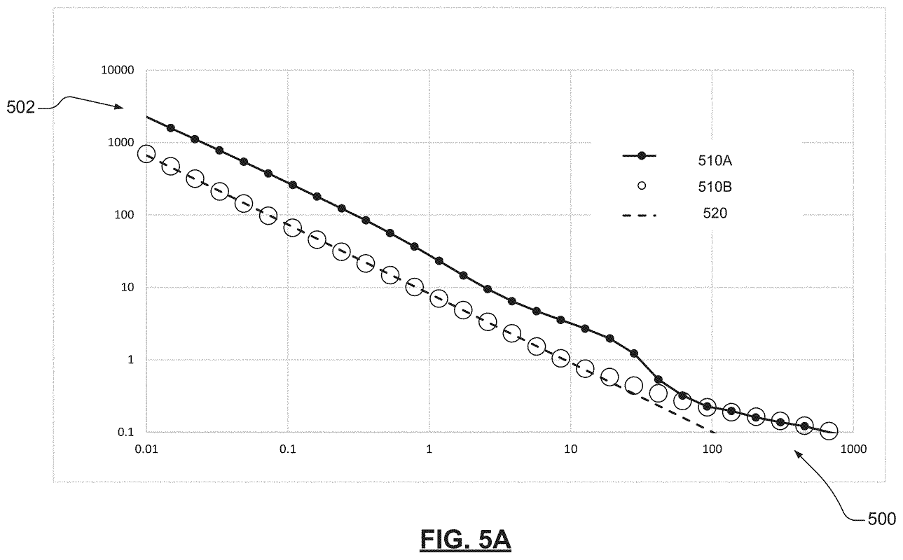

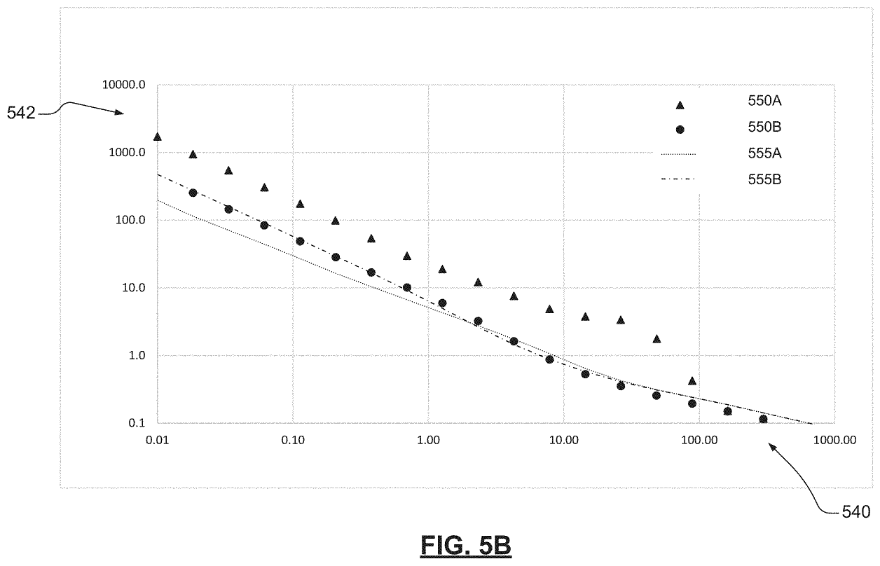

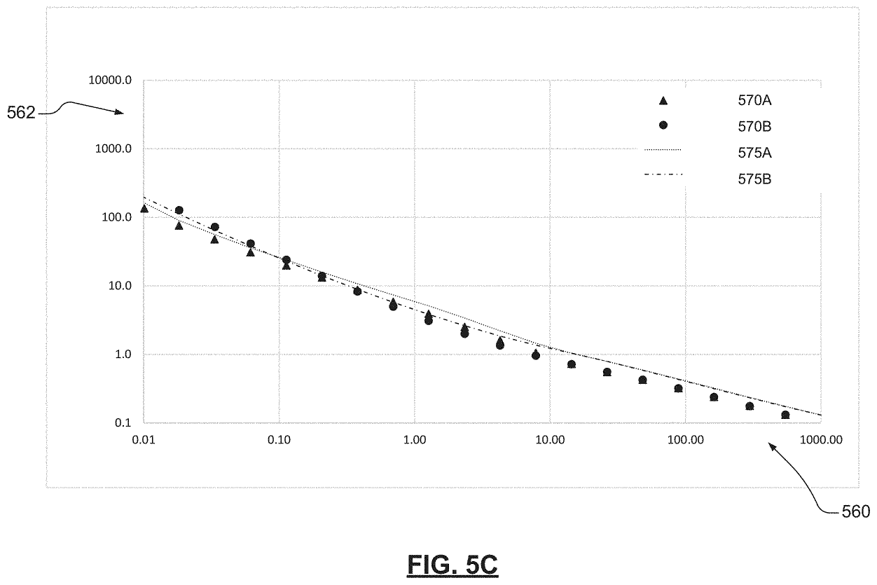

A first particle dispersion is prepared that represents a cathode material slurry to be used in the preparation of a positive electrode. The first particle dispersion includes carbon nanotubes (e.g., single-wall carbon nanotubes (SWCNT)) and a binder (e.g., polyvinylidene fluoride (PVdF)) and a solvent (e.g., N-methyl pyrrolidone (NMP)). FIG. 5A illustrates the shear rate hysteresis of the first particle dispersion, where the x-axis 500 represents applied shear rate (1/sec), and the y-axis 502 represents measured viscosity (Pa-s). The large hydrodynamic volume swept with individual or rope agglomerates causes significant dispersion viscosity at low solid contents. For example, because the rope agglomerate with alignment of the nanotube cylindrical axis has a higher aspect ratio, the resulting viscosity in up shear ramp is greater than the down-ramp, as illustrated. 510A illustrates the up ramp, and 510B illustrates the down ramp, where the power law (n=−1.0) is represented by 520.

A second particle dispersion is prepared that represents a cathode material slurry to be used in the preparation of a positive electrode. The second particle dispersion includes carbon nanotubes (e.g., single-wall carbon nanotubes (SWCNT)), a binder (e.g., polyvinylidene fluoride (PVdF)), and a solvent (e.g., N-methyl pyrrolidone (NMP)), as well as a polyvinyl-4-pyridine (PVPy) additive. FIG. 5B illustrates the shear rate hysteresis of the second particle dispersion, where the x-axis 540 represents applied shear rate (1/sec), and the y-axis 542 represents measured viscosity (Pa·s). The polyvinyl-4-pyridine (PVPy) additive is an effective dispersant at 2.4 mg polymer/m² carbon surface, but fails to provide sufficient colloidal stability at 0.8 mg/m² which is assigned to a weak adsorption isotherm in the second particle dispersion. 550A illustrates the up ramp after one cycle, and 550B illustrates the down ramp after one cycle. 555A illustrates the up ramp after three cycles, and 555B illustrates the down ramp after three cycles.

A third particle dispersion is prepared that represents a cathode material slurry to be used in the preparation of a positive electrode. The third particle dispersion includes carbon nanotubes (e.g., single-wall carbon nanotubes (SWCNT)), a binder (e.g., polyvinylidene fluoride (PVdF)), and a solvent (e.g., N-methyl pyrrolidone (NMP)), as well as a sulfonated aromatic ionomer additive (e.g., sPPP-H) in accordance with various aspects of the present disclosure. FIG. 5C illustrates the shear rate hysteresis of the second particle dispersion, where the x-axis 560 represents applied shear rate (1/sec), and the y-axis 562 represents measured viscosity (Pa-s). As illustrated, the sulfonated aromatic ionomer additive (e.g., sPPP-H) remains an effective dispersant even at the lower loading of 0.8 mg polymer/m². 570A illustrates the up ramp after on cycle, and 560B illustrates the down ramp after one cycle. 575A illustrates the up ramp after three cycles, and 575B illustrates the down ramp after three cycles. Thus, the sulfonated aromatic ionomer additive (e.g., sPPP-H) may be added directly to the carbon dispersion during preparing of a positive electrode.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for use in an electrochemical cell that cycles lithium ions, the electrode comprising:
a high-nickel electroactive material having greater than or equal to about 0.6 mole fraction of nickel; and
greater than or equal to about 0.1 wt. % to less than or equal to about 2 wt. % of a sulfonated aromatic ionomer additive.

2. The electrode of claim 1, wherein the high-nickel electroactive material is represented by:
LiM¹ₓM²_{y}M³_{z}M⁴_{(1-x-y-z)}O₂
where at least one of M¹, M², M³, and M⁴ is nickel (Ni) and the remaining members of M¹, M², M³, and M⁴ are transitions metals independently selected from the group consisting of: manganese (Mn), cobalt (Co), aluminum (Al), iron (Fe), and combinations thereof, and where 0≤x≤1, 0≤y≤1, and 0≤z≤1.

3. The electrode of claim 1, wherein the high-nickel electroactive material is selected from the group consisting of NMC (LiNi_{1-x-y}CoₓMn_{y}O₂) (where 0≤x≤1 and 0≤y≤1), NCMA (LiNi_{1-x-y-z}CoₓMn_{y}Al_{z}O₂) (where 0≤x≤1, 0≤y≤1, and 0≤z≤1), NCA (LiNi_{1-x-y}CoₓAl_{y}O₂, where 0≤x≤1 and 0≤y≤1), LNMO (LiNiₓMn₁₋ₓO₂, where 0≤x≤1) and combinations thereof.

4. The electrode of claim 1, wherein the electrode further comprises:
a second electroactive material, wherein the second electroactive material is selected from the group consisting of: lithium manganese oxide (Li₍₁₊ₓ₎Mn₂O₄, where 0.1≤x≤1) (LMO), lithium nickel manganese oxide (LiNi_{0.5}Mn_{1.5}O₄), lithium cobalt oxide (LiCoO₂) (LCO), lithium iron phosphate (LiFePO₄), lithium vanadium phosphate (LiVPO₄), lithium manganese iron phosphate (LiMn₁₋ₓFeₓPO₄, where 0≤x≤1), and combinations thereof.

5. The electrode of claim 4, wherein the electrode comprises:
greater than or equal to about 45 wt. % to less than or equal to about 99 wt. % of the high-nickel electroactive material; and
greater than 0 wt. % to less than or equal to about 49.5 wt. % of the second electroactive material.

6. The electrode of claim 1, wherein the sulfonated aromatic ionomer additive comprises:
a sulfonated derivate of poly(arylene ether) (SPAE), poly(arylene ether sulfone) (SPAES), poly(arylene sulfide) (SPAS), sulfonated polyimide (SPI), sulfonated polyphenylene (SPP), and combinations thereof; and
one or more cations selected from H⁺, Li⁺, Na⁺, K⁺, and NH₄⁺.

7. The electrode of claim 1, wherein the electrode further comprises:
greater than or equal to about 1 wt. % to less than or equal to about 10 wt. % of a binder.

8. The electrode of claim 7, wherein the binder has a molecular weight greater than or equal to about 200 kilodaltons (kD) to less than or equal to about 2000 kilodaltons (kD).

9. The electrode of claim 8, wherein the binder is selected from the group consisting of: polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, and combinations thereof.

10. The electrode of claim 1, wherein the electrode further comprises:
greater than or equal to about 0.5 wt. % to less than or equal to about 10 wt. % of an electronically conductive material.

11. The electrode of claim 10, wherein the electronically conductive material comprises:
greater than or equal to about 0.25 wt. % to less than or equal to about 10 wt. % of carbon black or acetylene black,
greater than or equal to about 0.1 wt. % to less than or equal to about 10 wt. % of graphene nanoplatelets, and
greater than or equal to about 0.05 wt. % to less than or equal to about 2 wt. % of carbon nanotubes.

12. A method for preparing an electrode for use in an electrochemical cell that cycles lithium ions, the method comprising:
contacting an electroactive material slurry with one or more surfaces of a current collector, wherein a solids portion of the slurry comprises
greater than or equal to about 45 wt. % to less than or equal to about 99 wt. % of a high-nickel electroactive material, the high-nickel electroactive material having greater than or equal to about 0.6 mole fraction of nickel; and
greater than or equal to about 0.1 wt. % to less than or equal to about 2 wt. % of a sulfonated aromatic ionomer additive.

13. The method of claim 12, wherein the solids portion of the slurry further comprises:
greater than or equal to about 1 wt. % to less than or equal to about 10 wt. % of a binder, the binder having a molecular weight greater than or equal to about 200 kilodaltons (kD) to less than or equal to about 2000 kilodaltons (kD).

14. The method of claim 12, wherein the solids portion of the slurry further comprises:
greater than or equal to about 0.5 wt. % to less than or equal to about 10 wt. % of an electronically conductive material.

15. The method of claim 14, wherein the electronically conductive material comprises:
greater than or equal to about 0.25 wt. % to less than or equal to about 10 wt. % of carbon black or acetylene black,
greater than or equal to about 0.1 wt. % to less than or equal to about 10 wt. % of graphene nanoplatelets, and
greater than or equal to about 0.05 wt. % to less than or equal to about 2 wt. % of carbon nanotubes.

16. The method of claim 12, wherein the high-nickel electroactive material is selected from the group consisting of NMC (LiNi_{1-x-y}CoₓMn_{y}O₂) (where 0≤x≤1 and 0≤y≤1), NCMA (LiNi_{1-x-y-z}CoₓMn_{y}Al_{z}O₂) (where 0≤x≤1, 0≤y≤1, and 0≤z≤1), NCA (LiNi_{1-x-y}CoₓAl_{y}O₂, where 0≤x≤1 and 0≤y≤1), LNMO (LiNiₓMn₁₋ₓO₂, where 0≤x≤1) and combinations thereof.

17. The method of claim 12, wherein the electrode further comprises:
greater than 0 wt. % to less than or equal to about 49.5 wt. % of a second electroactive material, wherein the second electroactive material is selected from the group consisting of: lithium manganese oxide (Li₍₁₊ₓ₎Mn₂O₄, where 0.1≤x≤1) (LMO), lithium nickel manganese oxide (LiNi_{0.5}Mn_{1.5}O₄), lithium cobalt oxide (LiCoO₂, LCO), lithium iron phosphate (LiFePO₄), lithium vanadium phosphate (LiVPO₄), lithium manganese iron phosphate (LiMn₁₋ₓFeₓPO₄, where 0≤x≤1), and combinations thereof.

18. The method of claim 12, wherein the sulfonated aromatic ionomer additive comprises:
a sulfonated derivate of poly(arylene ether) (SPAE), poly(arylene ether sulfone) (SPAES), poly(arylene sulfide) (SPAS), sulfonated polyimide (SPI), sulfonated polyphenylene (SPP), and combinations thereof; and
one or more cations selected from H⁺, Li⁺, Na⁺, K⁺, and NH₄⁺.

19. The method of claim 12, wherein the slurry further comprises a solvent, and the solvent is selected from the group consisting of: N-methyl pyrrolidone (NMP), dimethylacetamide (DMAc), dimethylformamide (DMF), dimethyl sulfoxide (DMSO) and combinations thereof, and wherein the solvent comprises greater than or equal to about 20% to less than or equal to about 50% of a weight of the slurry.

20. The method of claim 12, wherein the method further comprises:
preparing the electroactive material slurry by contacting the high-nickel electroactive material and the sulfonated aromatic ionomer additive with a solvent.
